(19) United States
(12) Patent Application Publication
(10) Pub. No.: US 2007/0098298 A1
(43) Pub. Date: May 3, 2007

(54) Imaging methods, apparatus, systems, media and signals

(75) Inventor: Qing-San Xiang, Vancouver (CA)

Correspondence Address: Ralph A. Dowell of DOWELL & DOWELL P.C., 2111 Eisenhower Ave, Suite 406, Alexandria, VA, 22314, US

(73) Assignee: The University of British Columbia

(21) Appl. No.: 11/591,616

(22) Filed: Nov. 2, 2006

Related U.S. Application Data
(60) Provisional application No. 60/732,124, filed on Nov. 2, 2005.

(51) Int. Cl. G06K 9/36; G06K 9/00

(52) U.S. Cl. 382/276; 382/128

(57) ABSTRACT

Methods, apparatus, computer-readable media and signals for imaging are disclosed. A method includes performing a phasor iteration process to identify a phase error phasor associated with: a first input image data set representing a first image of an object having at least a first component and a second component, and a second input image data set representing a second image of the object. The method further includes generating a first output image data set representing an image of the first component of the object, in response to the first and second input image data sets and the phase error phasor. The first and second components of the object may include first and second chemical components.

### CROSS-REFERENCE TO RELATED APPLICATIONS

This application claims the benefit of priority from U.S. provisional patent application Ser. No. 60/732,124 filed Nov. 2, 2005, which is hereby incorporated herein by reference.

### FIELD OF THE INVENTION

The present invention relates to imaging methods, apparatuses, systems, computer-readable media, signals and computer program products.

### BACKGROUND OF THE INVENTION

A wide variety of imaging techniques presently exist. A number of these techniques are phase-sensitive, such as magnetic resonance imaging (MRI), optical interferometry and radar imaging, to name but a few examples. One particular example of a phase-sensitive imaging technique is chemical shift imaging. Chemical shift imaging has a number of applications, including water-fat imaging analysis, which may be conducted on magnetic resonance (MR) images, for example. Water-fat imaging can be considered as the simplest type of chemical shift imaging for a binary system with only two spectral components. Although it is able to provide diagnostically valuable information about the content of water and lipids within each pixel, clinically, water-fat imaging by far is mostly used for the purpose of high quality fat-suppression. The fat image is typically discarded, while the water image serves as an excellent fat-suppressed image. Water-fat imaging is a superior alternative to less effective fat-suppression techniques such as RF pre-saturation or Short-Tau Inversion-Recovery (STIR), where image uniformity, contrast, and flexibility on sequence parameters are compromised.

Early approaches to water-fat imaging included the original Dixon method [1], as well as the method with Quadrature-Sampling (QS) [2-4]. The Dixon method acquires two images where the water and fat magnetization vectors are sampled when they are parallel and anti-parallel, i.e. at sampling angles of (0°, 180°) also known as “in-phase” and “opposed-phase”. Water and fat images are produced by adding and subtracting the two acquired images. The QS method acquires a single image which samples the two vectors when they are perpendicular, i.e. at a sampling angle of (90°), and outputs water and fat images as the real and imaginary parts of the complex data sampled. Theoretically, both approaches should work if there is no phase error. However, phase errors are inevitable in practice and thus both methods have to be further developed with effective phase correction to achieve successful clinical applications.

When phase errors are limited within a certain range, simple methods have been proposed to achieve phase correction for water-fat separation [5,6]. More generally, Yueng and Komos [7] added a “third point” at (−180°) to the double acquisitions at (0°, 180°) in Dixon method, and attempted phase correction by using phase unwrapping. This idea was later termed as the “3-point Dixon” method, which has lead to many variations including sampling schemes of either (−180°, 0°, 180°) or (0°, 180°,360°) as described by Glover [11] and others [8-13]. More publications in this family can be found in a newly published book [14]. Although these variations had some success in separating water and fat, the present inventor has appreciated that they have the following fundamental drawbacks. (i) Considerable redundancy exists in the sampled data. Specifically, for both (−180°, 0°, 180°) and (0°, 180°, 360°) sampling schemes, or even for a more general (−α, 0, α) sampling scheme, the equation describing the 3_{rd} acquisition is not independent but simply derivable from the other two [15-20] (also see Appendix I). (ii) The processing algorithm typically relies on general phase unwrapping which itself is very challenging and can be unreliable [21-23], especially when there are disconnected pieces of tissues in the field-of-view. (iii) Even when water and fat can be sometimes separated, there is no simple way to automatically distinguish them, i.e. to identify which is water and which is fat, analogous to the ambiguity of telling how the two hands on a clock rotate if they are only observed at parallel and anti-parallel. This can be a nuisance for multi-slice scans [10] or disconnected tissues in the field-of-view (FOV) where inconsistent water and fat segments can be displayed. Additional information which has been used recently, such as intensity histogram, helps to resolve this problem due to symmetric sampling [39,40], although this approach may not be necessarily effective if inconsistent water-fat assignment had occurred between disconnected tissues in the FOV.

In contrast to the many variations of the original Dixon method, the development of QS method has been relatively slow. There are limited number of publications and applications. However, the asymmetric sampling in the QS method has the potential to allow not only separation but also identification of the water and fat vectors given their definite leading and lagging phase relationship. A generalized method combining the two approaches, namely the original Dixon and the QS methods, has been employed as a more efficient technique for 3-point water-fat imaging [20]. The combined method is known as Direct Phase Encoding (DPE), which uses general asymmetric sampling schemes of (α₀, α₀+α, α₀+2α) including a previously described sampling scheme of (0°, 90°, 180°) as a special case [24]. An example of DPE is disclosed in commonly-owned U.S. Pat. No. 6,091,243, which issued to the present inventor on July 18, 2000, and which is hereby incorporated herein by reference. DPE eliminates the redundancy in the traditional “3-point Dixon” methods, allowing a simple and robust pixel-by-pixel calculation of water and fat content. DPE can achieve simultaneous water-fat separation and identification at a pixel level as long as the middle point is not sampled at an integer multiple of π, i.e. α₀+α≠nπ. It does not rely on the difficult general phase unwrapping, although for pixels containing only one chemical peak a much less challenging regional binary tracking of orientation vectors is needed. The asymmetric sampling allows the water and fat vectors to be not only separated but also uniquely identified based on their relative leading or lagging phase relationship, which was impossible when the two vectors were traditionally observed only at parallel and anti-parallel. In a DPE paper [20], a second-pass solution was also proposed after phase correction, which allowed SNR improvement in the final water and fat images. DPE is considerably more robust than methods relying on general phase unwrapping, and has been applied to a large number of clinical cases [25,26]. With DPE, it is possible to perform a pure phase encoding of the chemical shift information with three orthogonal acquisitions at (−90°, 90°, 270°), where all complex images have equal magnitude, allowing extraction and correction of T₂* effects [27]. An interesting extension of DPE is the possibility of a more efficient method for general spectroscopic imaging, termed chemical shift imaging by spectrum modeling (CSISM) [28] where N chemical components can be resolved by using only (N+2)/2 acquisitions with a least-squares approach. Although DPE was initially demonstrated with only simple spin-echo and gradient-echo sequences, its variations with accelerated phase mapping and other sequences, as discussed in the original DPE paper [20], have been later reported [29, 30].

Another water-fat imaging method was proposed using a least-squares approach [31], which was improved by a region-growing algorithm later [32]. The improved method is in fact similar to that used in CSISM [28] for more general chemical shift imaging.

### SUMMARY OF THE INVENTION

In accordance with one illustrative embodiment of the invention, there is provided an imaging method. The method includes performing a phasor iteration process to identify a phase error phasor associated with: a first input image data set representing a first image of an object having at least a first component and a second component, and a second input image data set representing a second image of the object. The method further includes generating a first output image data set representing an image of the first component of the object, in response to the first and second input image data sets and the phase error phasor.

Advantageously, as such a method requires only two input images, such a method requires shorter minimum scanning times than previous phase-corrected methods such as the 3-point Dixon method and the Direct Phase Encoding (DPE) method. Also advantageously, performing a phasor iteration process to identify the phase error phasor avoids various difficulties associated with previous phase correction approaches such as phase unwrapping, which attempted to solve the more difficult problem of identifying the phase itself (rather than the corresponding phasor). The present phasor iteration approach advantageously is able to self-correct for minor local errors in the evolution of the phasor, in contrast to previous region-growing algorithms, in which an accidental identification of a local rather than a global extremum or other accidental errors can often trigger catastrophic regional mistakes. The present phasor iteration approach tends to be more reliable and robust, and avoids the sometimes catastrophic sensitivity of previous approaches to discontinuities or other boundaries in the field of view, such as discontinuities in the tissues or other object(s) being imaged or boundaries between the different components of the object(s).

The first and second components of the object may include first and second chemical components, in which case generating may include generating a first output image data set representing an image of the first chemical component of the object. Advantageously, such embodiments may be applied to chemical shift imaging techniques, such as water-fat imaging, for example.

The method may further include generating a second output image data set representing an image of the second chemical component of the object. For example, where the first and second chemical components are water and fat, both a water image and a fat image may be separately produced.

Alternatively, the fat image may be discarded, and only the fat-suppressed water image may be retained, if desired.

The object may include organic tissue and the first and second chemical components of the object may include water and fat, respectively.

The second input image data set may represent an image of the object when magnetization vectors of protons of the first chemical component are in partially-opposed phase (POP) with magnetization vectors of protons of the second chemical component. The partially-opposed phase may include a phase shift other than a multiple of 180°.

For example, the partially-opposed phase may include a phase shift in the range of about 120° to about 240° other than 180°. To name but a few examples, the partially-opposed phase may include a phase shift of about 135°, or a phase shift of about 225°, or a phase shift of about 195°.

Alternatively, the partially-opposed phase may include a phase shift of about 90°, for example.

The first input image data set may represent an image of the object when magnetization vectors of protons of the first chemical component are in phase with magnetization vectors of protons of the second chemical component.

Alternatively, or in addition, the first input image data set may represent an image of the object when a phase shift between magnetization vectors of protons of the first chemical component and magnetization vectors of protons of the second chemical component differs from the partially-opposed phase of the second input image data set by an angular difference such that a cosine of the phase shift of the first input image data set is unequal to a cosine of the partially-opposed phase of the second input image data set.

The angular difference between the phase shift of the first input image data set and the partially-opposed phase of the second input image data set may be an angle other than a multiple of 180°.

The method may further include, for each pixel included in the first and second input image data sets, identifying a big chemical component and a small chemical component.

For example, identifying may include identifying the big and small chemical components as:

$$B = \frac{1}{2} [ \sqrt{\frac{{M}_{1}^{2} ( cos {θ}_{2} - 1 ) {M}_{2}^{2} ( cos {θ}_{1} - 1 )}{cos {θ}_{2} - cos {θ}_{1}}} + \sqrt{\frac{{M}_{1}^{2} ( cos {θ}_{2} + 1 ) {M}_{2}^{2} ( cos {θ}_{1} + 1 )}{cos {θ}_{2} - cos {θ}_{1}}} ]$$

$$S = \frac{1}{2} [ \sqrt{\frac{{M}_{1}^{2} ( cos {θ}_{2} - 1 ) {M}_{2}^{2} ( cos {θ}_{1} - 1 )}{cos {θ}_{2} - cos {θ}_{1}}} - \sqrt{\frac{{M}_{1}^{2} ( cos {θ}_{2} + 1 ) {M}_{2}^{2} ( cos {θ}_{1} + 1 )}{cos {θ}_{2} - cos {θ}_{1}}} ]$$

wherein:
B=the big chemical component for the pixel;
S=the small chemical component for the pixel;
M₁=a magnitude of image data of the first input image data set for the pixel;
M₂=a magnitude of image data of the second input image data set for the pixel;
θ₁=a phase shift between magnetization vectors of protons of the first chemical component and magnetization vectors of protons of the second chemical component for the first input image data set; and
θ₂=a phase shift between magnetization vectors of protons of the first chemical component and magnetization vectors of protons of the second chemical component for the second input image data set.

If the first input image data set represents an image of the object when magnetization vectors of protons of the first chemical component are in phase with magnetization vectors of protons of the second chemical component, then identifying may include identifying the big and small chemical components as:

$$\begin{matrix}B = \frac{1}{2} [ {M}_{1} + \sqrt{\frac{2 {M}_{2}^{2} - {M}_{1}^{2} ( 1 + cos α )}{1 - cos α}} ] \\ S = \frac{1}{2} [ {M}_{1} - \sqrt{\frac{2 {M}_{2}^{2} - {M}_{1}^{2} ( 1 + cos α )}{1 - cos α}} ]\end{matrix}$$

wherein:
B=the big chemical component for the pixel;
S=the small chemical component for the pixel;
M₁=a magnitude of image data of the first input image data set for the pixel;
M₂=a magnitude of image data of the second input image data set for the pixel;
α=a phase shift between magnetization vectors of protons of the first chemical component and magnetization vectors of protons of the second chemical component for the second input image data set.

Performing a phasor iteration process may include performing a regional iterative phasor extraction process to identify the phase error phasor.

The phase error phasor to be identified may include a phase error phasor associated with the second input image data set multiplied by a complex conjugate of a phase error phasor associated with the first input image data set.

Image data in the first input image data set for each pixel may be of the form I₁=(W+F)P₁, image data in the second input image data set for each pixel may be of the form I₂=(W+Fe^{iα})P₂, and the phase error phasor to be identified may be of the form P=P₂P₁*, wherein:
I₁, I₂ are complex-valued image data for the pixel from the first input image data set and from the second input image data set, respectively;
P₁, P₂ are complex-valued unknown error phasors associated with the first input image data set and with the second input image data set, respectively;
P₁*=the complex conjugate of P₁;
W=a real number representing a magnitude of the contribution from the first chemical component to the image data I₁, I₂;
F=a real number representing a magnitude of the contribution from the second chemical component to the image data I₁, I₂; and α=the partially-opposed phase of the magnetization vectors of the first and second chemical components for the second input image data set.

Performing the phasor iteration process may include identifying possible candidates for the phase error phasor to be identified. For example, the possible candidates may include:

a first candidate of the form

$${P}_{u} = \frac{{J}_{2}}{B + S {ⅇ}^{ⅈ α}} ;$$

and
a second candidate of the form

$${P}_{v} = \frac{{J}_{2}}{S + B {ⅇ}^{ⅈ α}} ;$$

wherein:
J₂=the complex-valued image data I₂ for the pixel from the second input image data set multiplied by the complex conjugate P₁* of the error phasor associated with the first input image data set, J₂=(W+Fe^{iα})P₂P₁*=(W+Fe^{iα})P;
B=a big chemical component=a real number representing a magnitude of the contribution from an unknown one of the first and second chemical components to the image data I₁, I₂; and
S=a small chemical component=a real number representing a magnitude of the contribution from the other one of the first and second chemical components to the image data I₁, I₂.
Performing the phasor iteration process may include setting a present iteration of the phase error phasor to be identified equal to an initial value.

This may include setting the present iteration of the phase error phasor to be identified in response to the possible candidates. For example, setting may include calculating the initial value as an average of the possible candidates. Alternatively, setting may include calculating the initial value in response to analysis of the possible candidates over a small region of pixels represented within the input image data sets.

Performing the phasor iteration process further may include smoothing the present iteration of the phase error phasor. Smoothing may include separately smoothing a real part and an imaginary part of the present iteration.

Smoothing may include executing a fast smoothing algorithm, such as an image domain fast smoothing algorithm, for example.

The smoothing may be achieved using a sliding window.

Performing the phasor iteration process further may include updating the smoothed present iteration of the phase error phasor for each pixel included in the first and second input image data sets.

Updating may include comparing the smoothed present iteration to possible candidates for the phase error phasor. For example, for each pixel, comparing may include identifying one of the possible candidates whose magnitude is closest to a magnitude of the smoothed present iteration, and updating may further include setting a next iteration of the phase error phasor equal to the identified one of the possible candidates. Updating may include setting a next iteration of the phase error phasor equal to zero if none of the possible candidates has a magnitude closer to that of the smoothed present iteration than any others of the possible candidates.

For example, updating may include, for each pixel, setting a next iteration Pₙ₊₁ of the phase error phasor equal to:

$${P}_{n + 1} = \{ \begin{matrix}{P}_{u} , & if \vert {P}_{u} - {P}_{n}^{S} \vert < \vert {P}_{v} - {P}_{n}^{S} \vert \\ {P}_{v} , & if \vert {P}_{u} - {P}_{n}^{S} \vert > \vert {P}_{v} - {P}_{n}^{S} \vert \\ 0 , & if \vert {P}_{u} - {P}_{n}^{S} \vert = \vert {P}_{v} - {P}_{n}^{S} \vert\end{matrix}$$

wherein Pᵤ and Pᵥ are the possible candidates and wherein Pₙ^{s} is the smoothed present iteration.

The method may further include repeating the smoothing and the updating to generate a plurality of successive iterations of the phase error phasor.

Repeating may include repeating the smoothing and the updating until a number of pixels for which a most recent iteration of the phase error phasor differs from an immediately preceding iteration of the phase error phasor has stabilized, to produce a stabilized phase error phasor for each pixel.

Performing the phasor iteration process may include identifying the phase error phasor associated with the first and second input image data sets, in response to the stabilized phase error phasor.

The method may further include smoothing and re-normalizing the stabilized phase error phasor, and identifying may include identifying the smoothed and re-normalized stabilized phase error phasor as the phase error phasor associated with the first and second input image data sets.

The method may further include re-performing the phasor iteration process with at least one different parameter to generate a verification phasor to be compared to the identified phase error phasor. For example, re-performing may include re-performing the smoothing using a sliding window of a different size than that of a sliding window used to produce the identified phase error phasor.

The method may further include comparing the verification phasor to the identified phase error phasor. Such a comparison may include comparing a smoothness of the verification phasor to a smoothness of the identified phase error phasor. The method may further include substituting the verification phasor for the identified phase error phasor if a pre-determined condition is satisfied. For example, this may include substituting the verification phasor for the identified phase error phasor if the verification phasor varies more smoothly than the identified phase error phasor.

Generating the first output image data set may include removing the phase error phasor from the first and second input image data sets.

Generating the first output image data set may include generating a least-squares solution for the first output image data set, in response to the phase error phasor associated with the first and second input image data sets. For example, generating may include generating the least-squares solution for the first output image data set subject to a constraint that the first output image data set be real.

Generating the first and second output image data sets may include generating real-valued least-squares solutions for the first and second output images data sets of the form:

$$[ \begin{matrix}{W}_{LS} \\ {F}_{LS}\end{matrix} ] = \frac{1}{3 + cos α} [ \begin{matrix}1 & 2 + cos α & sin α ( 1 + cos α ) / ( cos α - 1 ) \\ 1 & - 1 & 2 sin α / ( 1 - cos α )\end{matrix} ] [ \begin{matrix}{J}_{1} \\ Re ( {J}_{2}^{C} ) \\ Im ( {J}_{2}^{C} )\end{matrix} ]$$

wherein:
W_{LS}=a value of the first output image data set representing a magnitude of a pixel of an image of the first chemical component of the object;
F_{LS}=a value of the second output image data set representing a magnitude of a pixel of an image of the second chemical component of the object;
α=the partially-opposed phase of the magnetization vectors of the first and second chemical components for the second input image data set;

$$\begin{matrix}{J}_{1} = \vert {I}_{1} \vert and \\ {J}_{2}^{C} = \frac{{{I}_{2} ( \frac{{I}_{1}}{\vert {I}_{1} \vert} )}^{*}}{{P}_{stable}^{S}} ,\end{matrix}$$
wherein I₁ and I₂ are the complex-valued image data for the pixel from the first input image data set and from the second input image data set respectively, and P_{stable}^{S} is the phase error phasor associated with the first and second input image data sets.

Alternatively, generating may include generating a complex-valued solution for the first output image data set, in response to the phase error phasor associated with the first and second input image data sets.

The method may further include receiving and storing the first and second input image data sets.

The method may further include generating the first and second input image data sets. For example, generating the first and second input image data sets may include generating the first and second input image data sets with a magnetic resonance imaging (MRI) device.

The method may further include generating an output image of the first chemical component in response to the first output image data set. The method may also include generating a second output image of the second chemical component in response to the second output image data set.

Generating an output image may include displaying the output image on a monitor. Alternatively, or in addition, generating an output image may include printing the output image.

In accordance with another illustrative embodiment of the invention, there is provided an apparatus for imaging. The apparatus includes a processor circuit programmed or otherwise configured to perform a phasor iteration process to identify a phase error phasor associated with: a first input image data set representing a first image of an object having at least a first component and a second component, and a second input image data set representing a second image of the object. The processor circuit is further configured to generate a first output image data set representing an image of the first component of the object, in response to the first and second input image data sets and the phase error phasor.

More generally, the processor circuit may be configured to cause any of the various methods described herein to be carried out.

In accordance with another illustrative embodiment of the invention, there is provided a system including such an apparatus and further including an imaging device in communication with the processor circuit and configured to generate the first and second input image data sets. The imaging device may include a magnetic resonance imaging (MRI) device, for example.

The processor circuit may be remote from the imaging device. For example, the processor circuit may be housed in a computer separate from the imaging device. Alternatively, the processor circuit may be integral with the imaging device.

In accordance with another illustrative embodiment of the invention, there is provided a system including such an apparatus and further including an image output device in communication with the processor circuit. The processor circuit may be configured to control the image output device to generate an output image of the first component in response to the first output image data set. The processor circuit may similarly be configured to control the image output device to generate an output image of the second component in response to the second output image data set.

The image output device may include a display monitor. Alternatively, or in addition, the image output device may include a printer.

In accordance with another illustrative embodiment of the invention, there is provided a computer-readable medium storing instruction codes for directing a processor circuit to perform a phasor iteration process to identify a phase error phasor associated with: a first input image data set representing a first image of an object having at least a first component and a second component, and a second input image data set representing a second image of the object. The computer-readable medium further stores instruction codes for directing the processor circuit to generate a first output image data set representing an image of the first component of the object, in response to the first and second input image data sets and the phase error phasor.

More generally, the computer-readable medium may store instruction codes for directing a processor circuit to cause any of the methods described herein to be carried out.

In accordance with another illustrative embodiment of the invention, there is provided a signal embodied in a carrier wave, the signal including code segments for directing a processor circuit to cause any of the methods described herein to be carried out.

In accordance with another illustrative embodiment of the invention, there is provided a signal embodied in a communications medium, the signal including code segments for directing a processor circuit to cause any of the methods described herein to be carried out.

In accordance with another illustrative embodiment of the invention, there is provided an imaging apparatus including means for performing a phasor iteration process to identify a phase error phasor associated with: a first input image data set representing a first image of an object having at least a first component and a second component, and a second input image data set representing a second image of the object. The apparatus further includes means for generating a first output image data set representing an image of the first component of the object, in response to the first and second input image data sets and the phase error phasor.

More generally, the apparatus may include means for performing the various functions described herein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings that illustrate embodiments of the invention,

FIG. 1 is a block diagram of an imaging apparatus according to a first embodiment of the invention, shown in communication with an imaging device and an image output device.

FIG. 2 is a geometric interpretation of big and small chemical component (B, S) solutions obtained from the magnitude of in-phase and partially-opposed-phase (POP) images.

FIG. 3 is a graphical representation of an effective number of signal averages (NSA*) plotted as a function of α.

FIG. 4 is a flowchart of an illustrative chemical shift imaging routine stored in a computer-readable medium of the image processing apparatus shown in FIG. 1, for execution by a processor circuit of the image processing apparatus.

FIG. 5 illustrates error phasors as intermediate results, and water-fat images as final results of a spin-echo axial head scan with α=135°.

FIG. 6 illustrates (a) a water image, (b) a fat image, and (c) an image without fat suppression, obtained from a spin-echo coronal head scan, with α=135°.

FIG. 7 illustrates (a) water and (b) fat images obtained with α=135° from a spin-echo axial scan near neck and shoulder, where high quality RF fat-suppression is difficult to achieve.

FIG. 8 illustrates (a) water and (b) fat images obtained with α=195° from a breath-held axial abdominal scan with a double-echo gradient-echo sequence.

FIG. 9 illustrates (a) water and (b) fat images obtained with α=90° from a spin-echo axial scan of two feet.

### DETAILED DESCRIPTION

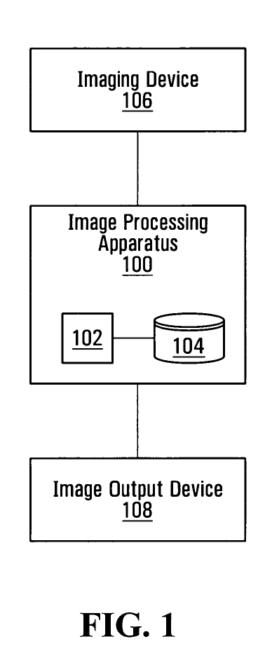

Referring to FIG. 1, an apparatus according to a first embodiment of the invention is shown generally at 100. In this embodiment, the apparatus 100 includes a processor circuit 102. In the present embodiment, the processor circuit 102 is configured to perform a phasor iteration process to identify a phase error phasor associated with: a first input image data set representing a first image of an object having at least a first component and a second component, and a second input image data set representing a second image of the object. The processor circuit 102 is further configured to generate a first output image data. set representing an image of the first component of the object, in response to the first and second input image data sets and the phase error phasor.

In the present embodiment, the first and second components of the object are first and second chemical components. More particularly still, in this embodiment the object is organic tissue and the first and second chemical components are water and fat, respectively. Thus, in this embodiment, the first output image data set, which the processor circuit 102 is configured to generate, represents an image of the first chemical component of the object.

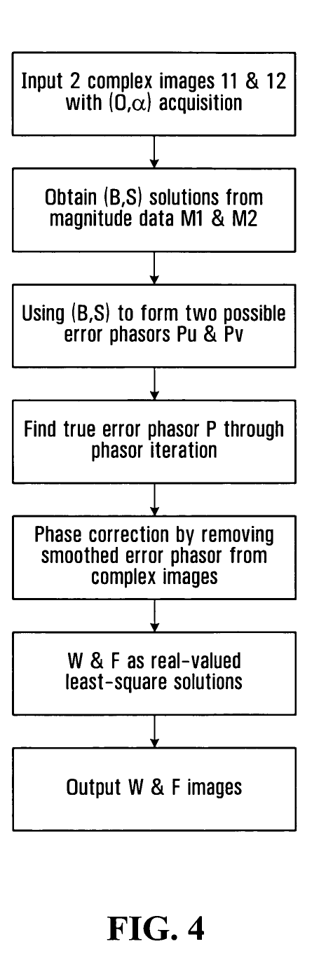

In this embodiment, the apparatus 100 further includes a computer-readable medium 104 in communication with the processor circuit 102. In this embodiment, the computer-readable medium 104 stores instruction codes for directing the processor circuit to cause the various methods disclosed herein to be carried out. For example, referring to FIGS. 1 and 4, in this embodiment the computer-readable medium 104 stores a chemical shift imaging routine shown in FIG. 4, which configures the processor circuit 102 to receive and store the first and second input image data sets, to perform the phasor iteration process, to generate the first output image data set, and more generally, to cause the various methods and functions described herein to be carried out. In this embodiment, the computer-readable medium 104 is also used to store the input and output image data itself. In this embodiment, the computer-readable medium includes a hard disk drive. Alternatively, however, any other suitable computer-readable medium or combination of media, such as compact discs (CDs), other types of magnetic disks or diskettes, optical storage devices, magnetic tapes, random access memories (RAMs), programmable read-only memories such as EPROMs, EEPROMs or FLASH memories, for example, or any other type of memory device, either at the location of the processor circuit or located remotely therefrom, may be substituted if desired.

Alternatively, it will be appreciated that placing the computer-readable medium 104 in communication with the processor circuit 102 is merely one way of generating signals comprising code segments for directing the processor circuit to cause the various methods and functions disclosed herein to be carried out. Alternatively, such signals may be embodied in a carrier wave and/or in a communications medium, and may be received by the processor circuit via any suitable input/output interface, such as an Internet connection or other wired or wireless network connection, for example.

In this embodiment, the processor circuit 102 of the apparatus 100 is in communication with an imaging device 106. More particularly, in this embodiment the imaging device 106 includes a magnetic resonance imaging (MRI) device. In this embodiment, the instruction routines and codes stored in the computer-readable medium 104 configure the processor circuit to communicate with the imaging device 106 to receive the first and second input image data sets therefrom, and to store the first and second input image data sets in the computer-readable medium 104. If desired, such routines may also configure the processor circuit 102 to control the imaging device 106 to generate the first and second input image data sets, by controlling radio-frequency (RF) and magnetization pulse sequences to achieve a desired phase shift between magnetization vectors of a first chemical component of an object being imaged and magnetization vectors of a second chemical component being imaged, for each input image data set.

In this embodiment, the apparatus 100 includes a general-purpose computer, separate from the imaging device 106. Alternatively, however, the apparatus 100 may include a specialized computing device, which may be either separate from or integral with the imaging device 106, as desired.

In this embodiment, the apparatus 100 is further in communication with an image output device 108. In the present embodiment, the routines stored in the computer-readable medium 104 configure the processor circuit 102 to control the image output device 108 to generate a first output image of the first chemical component of the object being imaged, in response to the first output image data set. The processor circuit may be similarly configured to control the image output device to generate a second output image of the second chemical component of the object. In this embodiment, the image output device includes a display monitor. Alternatively, or in addition, the image output device may include a printer. Alternatively, or in addition, the image output device may include a computer-readable medium for storing the output images in electronic form.

In the present embodiment, a novel application of a phasor iteration process to a phase-sensitive imaging technique is disclosed. As a specific example of such an application, a novel two-point chemical shift imaging method, or more particularly, a novel two-point water-fat imaging method, is introduced. In addition to an in-phase acquisition, in the present embodiment, water and fat vectors are sampled at partially-opposed-phase (POP) rather than exactly anti-parallel as in the original Dixon method. This asymmetric sampling allows more valuable phase information to be used in obtaining the water and fat solutions. With POP acquisition, water and fat can be not only separated but also uniquely identified. From the magnitude of the two acquired complex images, a big chemical component and a small chemical component are first solved pixel-by-pixel, and are used to form two possible error phasor candidates. The true error phasor is chosen from the two phasor candidates through a procedure of phasor iteration. Finally, least-squares solutions of water and fat are obtained after the error phasor is removed from the complex images. In terms of noise behavior, the effective number of signal averages NSA* is very close to the maximum possible value of 2. Compared to earlier approaches, the method of the present embodiment is efficient in data acquisition and straightforward in processing, yet robust in final results. A large number of in vivo scans covering a broad range of anatomical regions have demonstrated the clinical utility and robustness of the method.

The present embodiment describes a novel two-point method of water-fat imaging that is capable of both automatic separation and identification of the two chemical components. Like the original Dixon method, it acquires only two images, and therefore has a shorter minimum scan time than “3-point Dixon” methods and Direct Phase Encoding (DPE). Unlike the original Dixon method, in an illustrative embodiment, the water and fat vectors have a phase relationship of “in-phase” and “partially-opposed-phase (POP)”, i.e. the 2^{nd} image is a “POP” acquisition at a sampling angle close but not equal to 180°, such as 135°. The asymmetry in the POP acquisition allows water and fat vectors to be uniquely identified using phase information. The principle of the POP method will be described first, followed by specific implementations and in vivo applications, demonstrating its utility in clinical settings.

Solving for Big and Small Components from Two General Complex Images

The magnetic resonance (MR) signal behavior for a system of water and fat is well known [8, 11, 20]. If we acquire two complex MR images, ignoring relaxation effects, they can be written as,
I₁=(W+Fe^{iθ}^{₁})P₁ (1)
I₂=(W+Fe^{iθ}^{₁})P₂ (2)
where I₁ and I₂ are the two acquired complex images; W and F are non-negative real numbers representing the magnitudes of the water and fat peaks, respectively; θ₁ and θ₂ are known phase rotations between water and fat due to chemical shift effect, controlled by timing parameters of such pulse sequences as spin-echo, gradient-echo, combination of spin-echo and gradient-echo, RARE or fast-spin-echo, and SSFP [1, 11, 12, 20, 31]; and P₁ and P₂ are two unknown error phasors (complex numbers with magnitudes of unity) associated with the two image acquisitions. From Equations (1) and (2), we have the following two equations, corresponding to the geometry described by “Cosine Theorem” for a triangle with its two sides being the water and fat vectors,
M₁²=W²+F²+2WF cos θ₁ (3)
M₂²=W²+F²+2WF cos θ₂ (4)
where M₁ and M₂ are the magnitudes of I₁ and I₂. Assuming cos θ₁ and cos θ₂ are not equal, these quadratic equations yield two symmetric (W, F) solutions given below,

$$\begin{matrix}B = \frac{1}{2} [ \sqrt{\frac{{M}_{1}^{2} ( c os {θ}_{2} - 1 ) - {M}_{2}^{2} ( cos {θ}_{1} - 1 )}{cos {θ}_{2} - cos {θ}_{1}}} + \sqrt{\frac{{M}_{1}^{2} ( cos {θ}_{2} + 1 ) - {M}_{2}^{2} ( cos {θ}_{1} + 1 )}{cos {θ}_{2} - cos {θ}_{1}}} ] & ( 5 ) \\ S = \frac{1}{2} [ \sqrt{\frac{{M}_{1}^{2} ( cos {θ}_{2} - 1 ) - {M}_{2}^{2} ( cos {θ}_{1} - 1 )}{cos {θ}_{2} - cos {θ}_{1}}} - \sqrt{\frac{{M}_{1}^{2} ( cos {θ}_{2} + 1 ) - {M}_{2}^{2} ( cos {θ}_{1} + 1 )}{cos {θ}_{2} - cos {θ}_{1}}} ] & ( 6 )\end{matrix}$$

where B and S are the big and small chemical component within each pixel. In other words, the big chemical component B=a real number representing a magnitude of the contribution from an unknown one of the first and second chemical components to the image data I₁, I₂ and the small chemical component S=a real number representing a magnitude of the contribution from the other one of the first and second chemical components to the image data I₁, I₂, such that (B+S)=|I₁|=|I₂|.

The water-fat solutions (W, F) must be either (B, S) or (S, B) depending on whether water or fat is dominating. It is easy to see that when (θ₁, θ₂)=(0°, 180°) the B and S solutions reduce to the more familiar situation described in the original paper by Dixon [1],

$$\begin{matrix}B = \frac{{M}_{1} + {M}_{2}}{2} & ( 7 ) \\ S = \frac{{M}_{1} - {M}_{2}}{2} & ( 8 )\end{matrix}$$

Note that these solutions only provide the big and small components (B, S). A binary ambiguity still exists regarding which is water and which is fat.

There are infinite possible choices of sampling angles to achieve the same result (ignoring noise consideration), as long as cos θ₁≠cos θ₂. Some of these options have been investigated. They include (θ₁, θ₂)=(90°, 180°) [33] and (θ₁, θ₂)=(45°, 180°) [34], both of which sample the system asymmetrically, and were able to unambiguously output water and fat images. However, they do not include an in-phase acquisition therefore have intrinsic limitations for more general phase correction. These options also involve rather demanding post processing that is not straightforward and to be improved.

To further optimize two-point water fat imaging, in the present embodiment, a new sampling scheme of (θ₁, θ₂)=(0, α) is employed, where a is an angle close but not equal to 180°. This means that the two complex images are acquired at in-phase and at partially-opposed-phase (POP), which can be written as,
I₁=(W+F)P₁ (9)
I₂=(W+Fe^{iα})P₂ (10)
and the (B, S) solutions become,

$$\begin{matrix}B = \frac{1}{2} [ {M}_{1} + \sqrt{\frac{2 {M}_{2}^{2} - {M}_{1}^{2} ( 1 + cos α )}{1 - cos α}} ] & ( 11 ) \\ S = \frac{1}{2} [ {M}_{1} - \sqrt{\frac{2 {M}_{2}^{2} - {M}_{1}^{2} ( 1 + cos α )}{1 - cos α}} ] & ( 12 )\end{matrix}$$

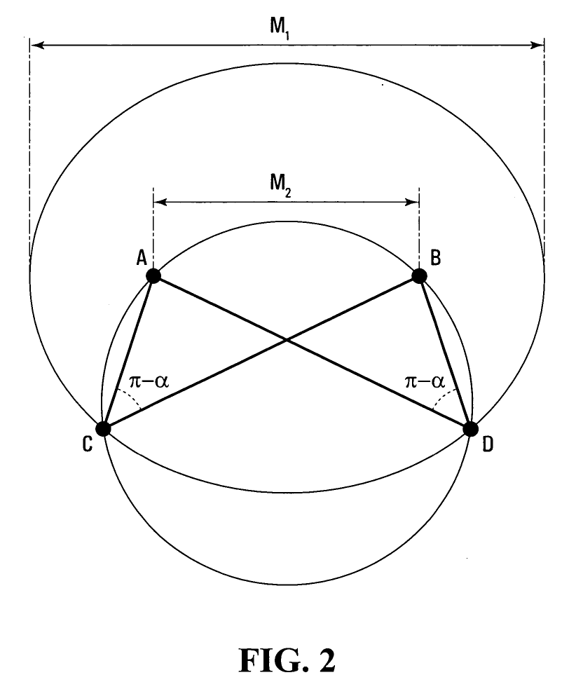

These solutions have a geometric interpretation as shown in FIG. 2. More particularly, FIG. 2 illustrates a geometric interpretation of big and small chemical component (B, S) solutions obtained from the magnitude of in-phase and partially-opposed-phase (POP) images. All points on the ellipse satisfy equation M₁=|W+F|; while all points on the circle satisfy equation M₂=|W+Fe^{iα}|. There are two solutions satisfying both equations, (B, S)=( A̅D̅, B̅D̅)=( B̅C̅, A̅C̅), defined by the two symmetric intercepts, C and D, of the ellipse and the circle along with the two foci, A and B, of the ellipse.

Relative Error Phasor P and its Two Possible Candidates (Pᵤ, Pᵥ)

Because I₁ is an in-phase acquisition, its error phasor P₁ is easily known and can be removed from I₁ and I₂ by multiplying its complex conjugate P₁*. Equations (9) and (10) are thus further simplified as,
J₁=I₁P₁*=W+F (13)
J₂=I₂P₁*=(W+Fe^{iα})P (13)
where P=P₂P₁* represents a relative error phasor between P₁ and P₂. W and F can be easily solved from Equations (13) and (14) if P can be found. Although this phasor P is not completely known, it must be restricted to one of the two possibilities given below, since the correct assignments of the (B, S) solutions must be either (B, S)=(W, F) or (B, S)=(F, W):

$$\begin{matrix}{P}_{u} = \frac{{J}_{2}}{B + S {ⅇ}^{ⅈ α}} & ( 15 ) \\ {P}_{v} = \frac{{J}_{2}}{S + B {ⅇ}^{ⅈ α}} & ( 16 )\end{matrix}$$

where Pᵤ and Pᵥ are two possible error phasors constructed from the (B, S) solution pairs. In general, Pᵤ and Pᵥ will have a definite leading and lagging phase relationship which is unavailable for an anti-parallel acquisition corresponding to α=180°due to the perfect symmetry between two vectors pointing in exactly opposite directions. The remaining task is to determine at each pixel which one of the two phasor candidates (Pᵤ, Pᵥ) should be chosen as the true error phasor P.

To avoid meaningless random phasors in regions of background noise only, in this embodiment, Equations (15, 16). are used along with a tissue mask to set Pᵤ=Pᵥ=0 for non-tissue pixels. Such a tissue mask is readily available by comparing all pixels in the big component map B in Equation (11), with the standard deviation of a noise field obtained as the difference between M₁ and the sum of B and S. If and only if the value of a pixel is greater than a threshold, say six times the standard deviation, it is considered as tissue. Although this threshold value is not critical to the final result, a rather high value was chosen in the present embodiment to ensure that the surviving pixels are indeed tissues, otherwise more processing time might be needed due to remaining pixels with random phase.

Phasor Iteration

The present embodiment employs an iterative procedure to take the two possible phasors (Pᵤ, Pᵥ) as input, and output the desired true phasor P. This phasor iteration procedure can be considered as a type of “cellular automata” [35] where interesting long range global structures can be developed from only local iterations following a set of simple rules. Cellular automata have been employed to study a two-state lattice called “Ising model” in physics [36], as well as to solve the problem of phase unwrapping [37] that is related to water-fat imaging.

In this embodiment, the phasor iteration procedure includes the following four operations: initialization, smoothing, updating, and repeating.

1) Initialization. The phasor iteration begins with an initial state P₀. For typical cases, a good result can be obtained by setting P₀ as a simple averaging of the two phasor candidates of Pᵤ and Pᵥ. Alternatively, however, to ensure robustness for more challenging cases associated with extraordinary phase error, noise, and artifacts, a more sophisticated way of setting up the initial state P₀ is described as the following.

The field of view (FOV) is divided into an array of small non-overlapping square regions, each with a size of K×K (e.g. K=8) pixels. Within each small region, various configurations chosen from (Pᵤ, Pᵥ) at each pixel are tested. More particularly, in the present embodiment, at each pixel, there are two possible choices between the two possible error phasor candidates, namely Pᵤ and Pᵥ. A “configuration” corresponds to a given distribution or combination of these choices. Therefore, for a region with K×K pixels, there are 2^{K×K} possible configurations or combinations of the error phasor candidates.

A configuration is selected as P_{S} if it maximizes the total regional “magnetization” M_{S}, defined as the magnitude of total phasor P_{S} summed over all pixels in the region. This configuration corresponds to a minimum regional phasor “dephasing” to reflect the fact that the true phase error P is nearly a constant in the small region. For the unselected complementary phasor configuration, its total magnetization M_{C} is also computed and a parameter C is defined as the refocusing contrast between the two configurations,

$$C = \frac{\vert {M}_{S}^{2} - {M}_{C}^{2} \vert}{\vert {M}_{S}^{2} + {M}_{C}^{2} \vert} \qquad ( 17 )$$

The final initial state P₀ is taken as the selected phasor P_{S} weighted by the contrast C which is significantly greater at tissue boundaries between water and fat than in areas with only a single one of the two chemical components such as the brain. In other words, the initial state P₀ is found with more confidence near tissue boundaries, where more weight is given to establish “seeds” in subsequent phasor iteration.

Multi-scale phasor initialization can also be performed by repeating the above procedure with various region sizes K and averaging the results from all levels as the final P₀.

2) Smoothing. The initial weighted phasor P₀ is smoothed. After each subsequent iteration (see step 4), the smoothing is performed again. In general, at each step of the iteration, the resulting phasor from the previous step, Pₙ, is smoothed in complex form, namely the real and imaginary parts are smoothed separately to yield the resultant P_{S}ⁿ,
P_{S}ⁿ≡Smooth (Pₙ) (18)

In this embodiment, a sliding window is used for smoothing. Typically, a larger window gives better results, as long as the local relative phase error does not vary too much within the window. A window of 37×37 pixels was used for the data acquired on our clinical scanners. A fast smoothing algorithm was used to speed up this operation (see Appendix II).

3) Phasor updating. After the smoothed phasor Pₙ^{S} is obtained, it is compared with the two phasor candidates (Pᵤ, Pᵥ) and a new phasor Pₙ₊₁ is updated according to,

$${P}_{n + 1} = \{ \begin{matrix}{P}_{u} , & if \vert {P}_{u} - {P}_{n}^{S} \vert < \vert {P}_{v} - {P}_{n}^{S} \vert \\ {P}_{v} , & if \vert {P}_{u} - {P}_{n}^{S} \vert > \vert {P}_{v} - {P}_{n}^{S} \vert \\ 0 , & if \vert {P}_{u} - {P}_{n}^{S} \vert = \vert {P}_{v} - {P}_{n}^{S} \vert\end{matrix} \qquad ( 19 )$$

In other words, the phasor is updated for every pixel by choosing, from either Pᵤor Pᵥ, the one that is closer to the smoothed value of P_{S}ⁿ; and is set to zero if there is a tie. To monitor the state of the phasor evolution, an integer variable N is used as a counter to record the total number of changed pixels at each step of iteration. Pixels that are different between steps n and n+1 are counted.

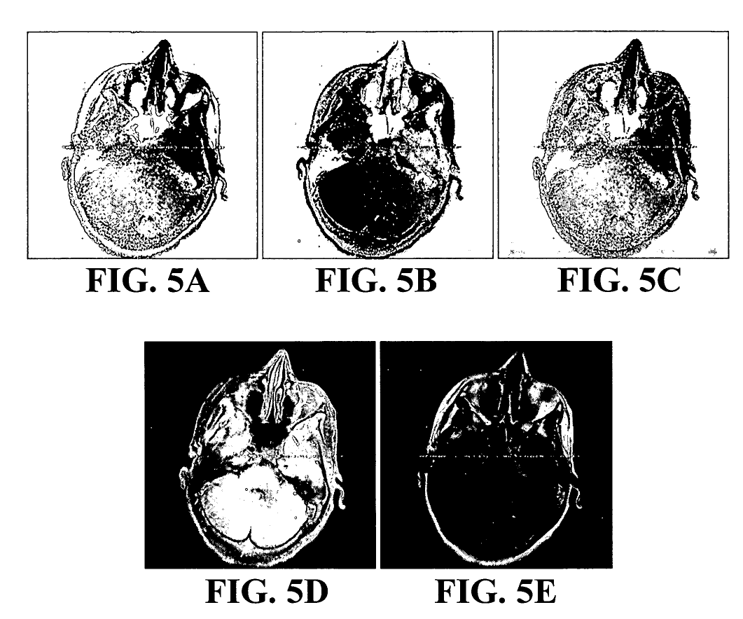

4) Repeating. If the number of changed pixels N is not stabilized, the operations 2) and 3) are repeated. Here stabilization means that N either reduces to zero or a small constant as the number of iteration n increases. In noisy data, it may be possible for N to fall into a periodic pattern although it is expected that this will be very rare. When N is eventually stabilized, it is usually equal or close to zero meaning none or very few pixels are undetermined. At this time, the phasor iteration can be terminated and the result is output as P_{stable}. Typically, N is quickly stabilized after only a few steps. For example, the resulting sequence of N for the data presented in FIG. 5 is (27816, 323, 40, 9, 2, 2, 1, 0).

Optional Repetition of Entire Phasor Iteration Process

If desired, the entire phasor iteration process may be re-performed, with at least one different parameter, to generate a verification phasor to be compared to the identified phase error phasor. For example, in this embodiment, the chemical shift imaging routine stored in the computer-readable readable medium 104 configures the processor circuit 102 to re-perform the smoothing at each iterative step (step 2) using a sliding window of a different size than that of a sliding window used to produce the identified phase error phasor. Thus, instead of a sliding window having dimensions of 37×37 pixels, other sizes of sliding windows, such as 21×21 pixels or 51×51 pixels for example, may be used. The sliding windows are preferably square, and each linear dimension preferably has an odd number of pixels, so that the window has a “central” pixel. Repeating the entire phasor iteration process in this manner with a differently sized smoothing window may be advantageous for certain situations. For example, if magnets of the imaging device are poor quality (producing relatively inhomogeneous fields), the assumption of a relatively constant error phasor over the window's region may be questionable, and use of a smaller window may yield improved results. Conversely, for typical or high quality magnets, use of larger sliding windows may yield more stable processing.

In this embodiment, the chemical shift imaging routine stored in the computer-readable medium 104 configures the processor circuit 102 to compare the verification phasor to the identified phase error phasor. More particularly, in this embodiment this comparison includes comparing a smoothness of the verification phasor to a smoothness of the identified phase error phasor.

In the present embodiment, the chemical shift imaging routine stored in the computer-readable medium 104 configures the processor circuit 102 to substitute the verification phasor for the identified phase error phasor if a pre-determined condition is satisfied. More particularly, in this embodiment the processor circuit is configured to substitute the verification phasor for the identified phase error phasor if the verification phasor varies more smoothly than the identified phase error phasor.

In this embodiment, the chemical shift imaging routine stored in the computer-readable medium 104 configures the processor circuit 102 to cause the generation of the verification phasor, the comparison of the verification phasor to the identified phase error phasor, and the substitution of the verification phasor for the identified phase error phasor if the pre-determined condition is satisfied, to be performed automatically. Alternatively, such re-performing steps may be carried out only if requested by an operator of the apparatus 100.

Or, as a further alternative, such re-performing steps may be omitted entirely, if desired. In this regard, re-performing the phasor iteration process tends to increase the reliability of the results, at the expense of increasing the processing time required to generate the output image data sets. With the computing power available on typical modern computers and processors, the increased processing time for many applications tends to be negligible from the perspective of a human operator or technician awaiting the results. Nevertheless, if processing time is critical for a particular application, such re-performing steps may be omitted to reduce the required processing time.

As an alternative to or in addition to re-performing the phasor iteration process by varying window size, such re-performing steps may be carried out by varying one or more other parameters, such as by applying additional phase corrections, for example.

Error Phasor Removal and Least-Squares Solutions of (W, F)

In this embodiment, the output of the phasor iteration P_{stable} is selected at each pixel from the two phasor candidates (Pᵤ, Pᵥ). Ideally, it represents the true error phasor P in Equation (14) with a smooth spatial variation. In reality, however, it may not be ideally smooth due to the following reasons. First, the P_{stable} map can have small “holes” at those pixels being replaced by zeros in Equation (19). Secondly, the noise in the (B, S) solutions may have impact on the phasor candidates (Pᵤ, Pᵥ), and result in some roughness of P_{stable}. These issues can be handled by using a second-pass (W, F) solution similar to that used in the DPE method [20]. The phasor P_{stable} is first heavily smoothed (e.g. 13×13 sliding window) and re-normalized as defined below,

$${P}_{stable}^{S} ≡ \frac{Smooth ( {P}_{stable} )}{\vert Smooth ( {P}_{stable} ) \vert} \qquad ( 20 )$$

The smoothed and re-normalized phasor P_{stable}^{S} is then removed from J₂ in Equation (14) resulting in a phase corrected complex POP image J₂^{C},

$$\begin{matrix}{J}_{2}^{C} = \frac{{J}_{2}}{{P}_{stable}^{S}} \\ = W + F {ⅇ}^{ⅈ α}\end{matrix} \qquad ( 21 )$$

Combining the above equation and Equation (13), we have the following linear system,
AX=J (22)
where the three matrices are defined as,

$$\begin{matrix}X = [ \begin{matrix}W \\ F\end{matrix} ] & ( 23 ) \\ A = [ \begin{matrix}1 & 1 \\ 1 & cos α \\ 0 & sin α\end{matrix} ] \\ and & ( 24 ) \\ J = [ \begin{matrix}{J}_{1} \\ Re ( {J}_{2}^{C} ) \\ Im ( {J}_{2}^{C} )\end{matrix} ] & ( 25 )\end{matrix}$$

where the operators Re( ) and Im( ) respectively return the real and imaginary parts of the complex number in the parentheses. These equations describe an over-determined system as there are three equations but only two unknowns. Therefore, a least-squares solution for (W_{LS}, F_{LS}) can be found as the final water and fat images,
X_{LS}=L J (26)
where L is the “pseudo-inverse” matrix given by,

$$L = {[ {A}^{T} A ]}^{- 1} {A}^{T} = \frac{1}{3 + cos α} [ \begin{matrix}1 & 2 + cos α & sin α ( 1 + cos α ) / ( cos α - 1 ) \\ 1 & - 1 & 2 sin α / ( 1 - cos α )\end{matrix} ] \qquad ( 27 )$$

where the superscripts “T” and “−1” are respectively “transpose” and “inverse” matrix operations. Finally, the least-squares solution X_{LS} can be explicitly written as,

$$[ \begin{matrix}{W}_{LS} \\ {F}_{LS}\end{matrix} ] = \frac{1}{3 + cos α} [ \begin{matrix}1 & 2 + cos α & sin α ( 1 + cos α ) / ( cos α - 1 ) \\ 1 & - 1 & 2 sin α / ( 1 - cos α )\end{matrix} ] [ \begin{matrix}{J}_{1} \\ Re ( {J}_{2}^{C} ) \\ Im ( {J}_{2}^{C} )\end{matrix} ] \qquad ( 28 )$$

wherein J₁=I₁P₁*=(W+F)P₁P₁*=W+F=B+S=|I₁|=the absolute magnitude of the original complex-valued image data I₁ for the pixel from the first input image data set, wherein

$$\begin{matrix}{J}_{2}^{C} = \frac{{J}_{2}}{{P}_{stable}^{S}} \\ = \frac{{I}_{2} {P}_{1}^{*}}{{P}_{stable}^{S}} \\ = \frac{{{I}_{2} ( \frac{{I}_{1}}{B + S} )}^{*}}{{P}_{stable}^{S}} \\ = \frac{{{I}_{2} ( \frac{{I}_{1}}{\vert {I}_{1} \vert} )}^{*}}{{P}_{stable}^{S}} ,\end{matrix}$$

wherein I₂ is the original complex-valued image data for the pixel from the second input image data set, and P_{stable}^{S} is the phase error phasor associated with the first and second input image data sets, which in this embodiment is determined from equation (20) above.
Analysis of Noise Behavior

The noise variances σ_{W}² and σ_{F}² in the final water and fat images, given by the linear solutions of (W_{LS}, F_{LS}), depends on the “pseudo-inverse” matrix L and can be calculated as,
σ_{W}²=(L₁₁²+L₁₂²+L₁₃²)σ₀² (29)
σ_{F}²=(L₂₁²+L₂₂²+L₂₃²)σ₀² (30)
where Lᵢⱼ are elements of matrix L in Equation (27); σ₀² is the noise variance in the real or imaginary parts of the phase corrected complex images, assumed to be a constant. This is a good approximation considering the fact that the phasor removal operations in Equations (13) and (21) affect noise variance very little, especially with the heavily smoothed phasor P_{stable}^{S}. It is straightforward to show that both noise variances σ_{W}² and σ_{F}² in Equations (29) and (30) are given by,

$$\begin{matrix}{σ}_{W}^{2} = {σ}_{F}^{2} \\ = \frac{2}{( 3 + cos α ) ( 1 - cos α )} {σ}_{0}^{2}\end{matrix} \qquad ( 31 )$$

Consequently, the effective number of signal averages NSA* [10, 20] for both water and fat images is,

$${NSA}^{*} = \frac{{σ}_{0}^{2}}{{σ}_{W}^{2}} = \frac{{σ}_{0}^{2}}{{σ}_{F}^{2}} = \frac{( 3 + cos α ) ( 1 - cos α )}{2} \qquad ( 32 )$$

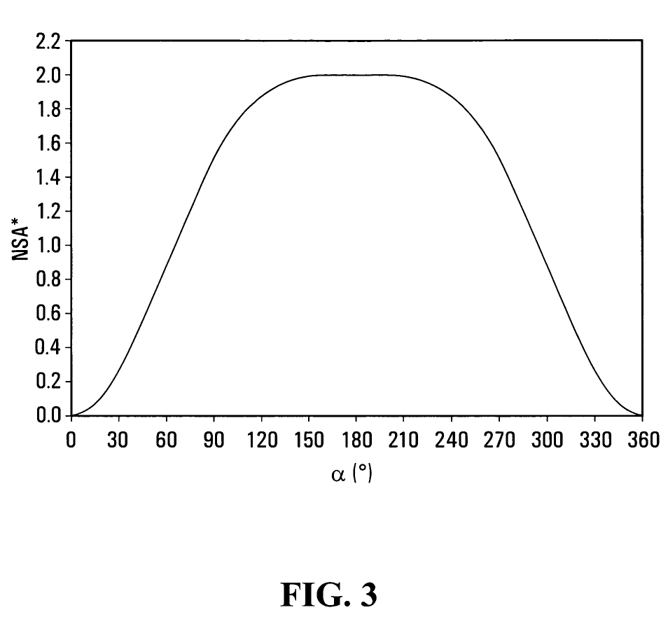

The NSA* as a function of angle α is plotted as FIG. 3, where a rather wide central plateau can be seen suggesting a desirable insensitivity of NSA* to the sampling angle α. In a region near α=180°, the NSA* varies slowly and stays approximately equal to the maximum possible value of 2. In the interval of (120°, 240°), the NSA* is higher than 1.875. In particular, at α=135°, the NSA* equals 1.957 which is quite close to the maximum possible value of 2. Compared with the traditional (0°, 180°) sampling, the small price paid in NSA* is justified by the ability of uniquely identifying the two chemical components.

Materials and Methods

Pulse Sequences and Experiments

The technique has been implemented on 1.5T clinical scanners (TwinSpeed, GE Healthcare, Waukesha, Wis., USA and Edge, Picker International, Cleveland, Ohio, USA) at local hospitals in Vancouver, Canada in a user-friendly manner such that technologists can perform the entire procedure, including complex image acquisition and water-fat image reconstruction without supervision. Standard spin-echo pulse sequences were modified to acquire interleaved complex images. The modified sequences were similar to those for a typical scan of two averages, except the 180° refocusing RF pulse for the second excitation is shifted in time by 0.84 ms, and the data were not averaged but reconstructed into two separate complex images corresponding to (0°, 135°) sampling. Advantageously, interleaving the two acquisitions between sampling angles of (0°, 135°) avoids mis-registration caused by gross motion of subjects. The sequences were also made compatible with array coils. For each coil element, the two complex images were first phase corrected according to Equations (13, 14). After this “phase alignment”, images from all coil elements were subsequently averaged with magnitude weighting to form a combined set of two complex images, corresponding to a complex version of “sum of squares” algorithm, leading to a single set of combined water and fat images. Hundreds of cases have been performed in Canada, covering many parts of the body, including head, neck, shoulder, arms, wrists, hands, chest, spine, abdomen, pelvis, thighs, legs, calves, and feet in axial, sagittal, coronal, and oblique slice orientations. Each case contains 13 to 28 slices, typically with T₁ weighted contrast using TR/TE=600-800/8-24 ms. Double-echo gradient-echo sequence was also used to acquire two complex images at TE₁=2.1 ms and TE₂=4.6 ms, resulting in POP and in-phase acquisitions respectively. Four-element array coils were used for improved signal to noise ratio.

Data Processing

In this example, water and fat images are obtained from the two complex images acquired with (0,α) sampling by steps summarized in FIG. 4. More particularly, referring to FIGS. 1 and 4, FIG. 4 shows an illustrative chemical shift imaging routine stored in the computer-readable medium 104 of the image processing apparatus 100. In this embodiment, the chemical shift imaging routine shown in FIG. 4 configures or programs the processor circuit 102 to obtain water and fat images from two complex images acquired with (0, α) sampling, where α is an angle close but not equal to 180°, e.g. α=135°, forming a partially-opposed phase (POP) acquisition. In this embodiment, the chemical shift imaging routine has been written in C-language to carry out fully automatic processing without human intervention. Since the phasor iteration uses large window smoothing at each step, a fast algorithm was used to improve the processing speed (see Appendix II).

Results

FIG. 5 shows error phasors as intermediate results, and water-fat images as final results from a spin-echo axial head scan with α=135°. FIGS. 5(a) and (b) are imaginary parts of the two phasor candidates, Pᵤ and Pᵥ, obtained from Equations (15, 16). FIG. 5(c) is the corresponding imaginary part of the final stabilized result, i.e. the resultant phasor P_{stable} after phasor iteration, which is smoother than Pᵤ and Pᵥ, representing the true error phasor without contribution from chemical shift effects. Each pixel in (c) is selected from either (a) or (b) by phasor iteration such that a global smoothness is achieved, as indicated by the more uniform contrast in (c).

FIG. 5(d) is a water image, and FIG. 5(e) is a fat image, both obtained as real-valued least-squares solutions from Equation (28), after the error phasor corresponding to FIG. 5(c) is removed.

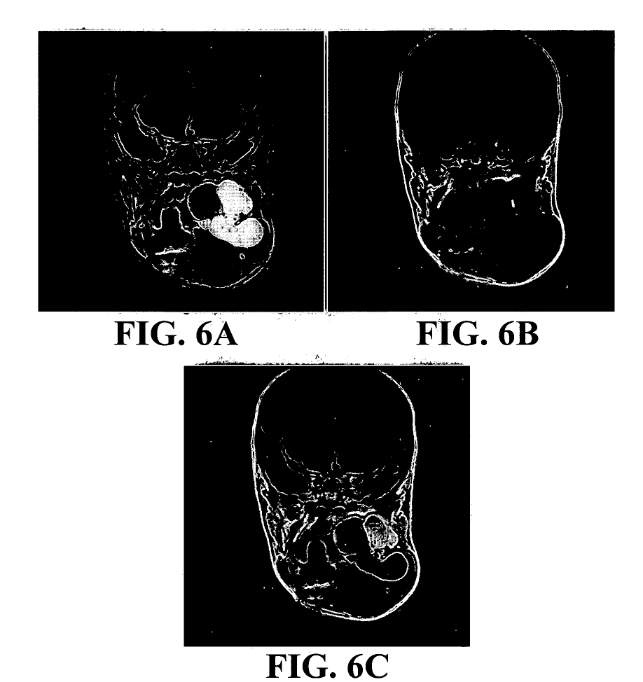

FIG. 6 shows results from a spin-echo coronal head scan with POP at α=135°. More particularly, FIG. 6(a) illustrates a water image and FIG. 6(b) illustrates a fat image, both of which are of excellent quality. The lesion is highlighted better visualized in the water image shown in FIG. 6(a), as compared with FIG. 6(c), which shows an image without fat suppression where strong signals from fatty tissue can be seen.

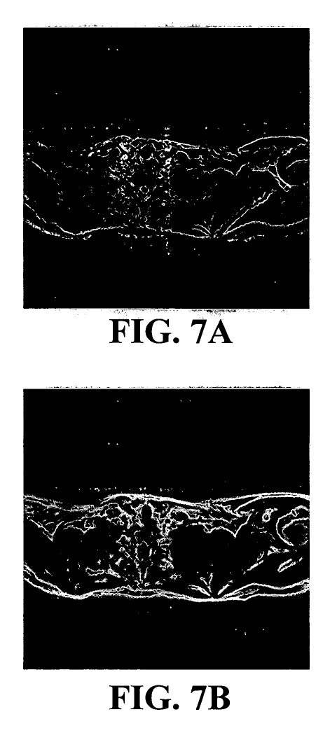

FIG. 7 shows results from a spin-echo axial scan near neck and shoulder with α=135°. More particularly, FIG. 7(a) shows a water image, while FIG. 7(b) shows a fat image, both of which are of excellent quality. In contrast, for this neck and shoulder region, high quality RF fat-suppression is difficult to achieve using prior approaches.

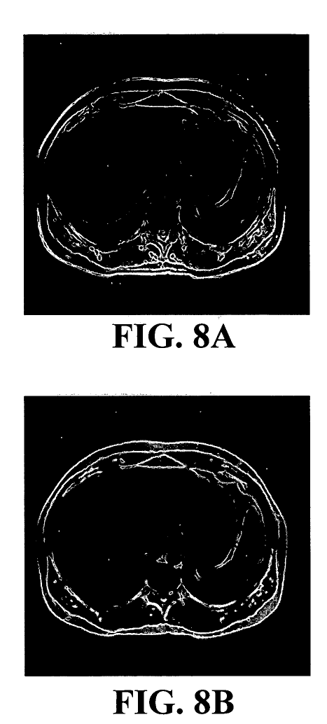

FIG. 8 shows a water image in FIG. 8(a) and a fat image in FIG. 8(b), obtained from a breath-held axial abdominal scan with a double-echo gradient-echo sequence using TE₁=2.1 ms and TE₂=4.6 ms, corresponding to approximate sampling angles of (θ₁, θ₂)=(165°, 360°). If we consider the 360° image as an in-phase. acquisition, the POP acquisition was at a relative sampling angle of α=195°. Four-element array coils were used, resulting in four sets of complex images, which were first phase corrected separately using Equations (13, 14), then combined with magnitude weighting before the phasor iteration and final water-fat solution. These water-fat separation and identification are both excellent, demonstrating the robustness and flexibility of the disclosed method, in terms of pulse sequences and coil configurations.

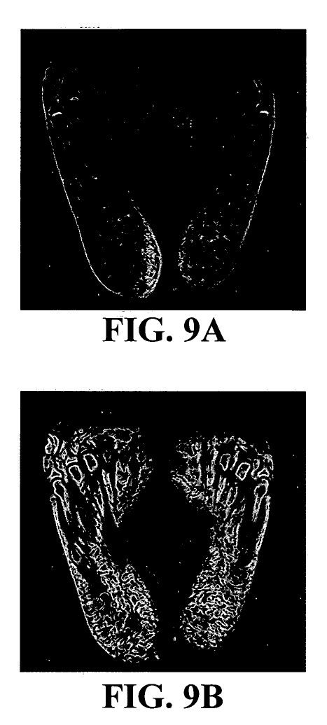

FIG. 9 shows a water image in FIG. 9(a) and a fat image in FIG. 9(b), obtained from a spin-echo axial scan of two feet. The sampling scheme was (0°, 90°), chosen from an earlier 3-point water-fat imaging data set acquired with DPE using a (0°, 90°, 180°) sampling scheme [20, 25, 26]. Although at this POP angle, the signal-to-noise-ratio is relatively low (NSA*=1.5), the water-fat separation and identification are still satisfactory, suggesting flexibility and robustness of the method. The two feet were imaged as two separate pieces of tissues in the field-of-view, which were automatically and correctly handled by the method of the present embodiment, although such discontinuities can be problematic for some previous water-fat imaging methods.

In the present example, the processing time is moderate. It depends on the particular data set since phasor iteration is involved. Typically, on a personal computer with 2.8 GHz clock rate and 504 MB-RAM memory, it takes about 0.8 seconds to process a slice with a 256×256 matrix size.

A technique similar to that of the present embodiment has been used in local hospitals in Vancouver, Canada in situations when a decent fat-suppression was needed especially in anatomically challenging regions. Mostly, it has replaced the DPE implementation [20] for its shorter scan time and improved performance.

Discussion

In the present embodiment, the water-fat system is sampled at two asymmetric points (0, α), encoding the chemical shift information into both magnitudes and phases of a pair of complex images. From the magnitudes alone, the big and small chemical components (B, S) are easily and robustly solved pixel-by-pixel in a more general manner than in the original two-point Dixon method [1]. The remaining binary ambiguity (i.e. which component is water, which is fat) is further resolved through a straightforward procedure of phasor iteration.

Compared with early approaches [15-19] based upon phase unwrapping with symmetric sampling at (0°, 180°), the method of the present embodiment has a number of advantages. Water and fat can be not only separated but also uniquely identified, which was hardly possible when the two vectors were only sampled at parallel and anti-parallel. The present embodiment achieves the necessary phase correction by choosing two candidate phasors instead of performing the far more difficult task of general phase unwrapping, resulting in favorable simplicity and robustness. In general, finding a phasor is much easier than determining the corresponding phase. For a pixel, it is trivial to find the corresponding phasor if the phase is known, but it can be very challenging to determine the phase from a given phasor due to ambiguity induced by phase aliasing. In the problem of water-fat imaging, the present inventor has appreciated that only the correct error phasor is needed after all. Therefore, the present inventor has appreciated that a method focused on phasor treatment is more suitable to this particular problem. Although such an analogy may not necessarily be apparent to one of ordinary skill in the art without the benefit of the present disclosure, the present inventor draws comparison to a similar problem of polarity treatment originally used in phase corrected inversion-recovery image reconstruction [38] and recently adopted for water-fat imaging [40].

The mechanism of phasor iteration involves dynamics of cellular automata [35], and a thorough analysis is unnecessary to fully describe the present invention and is hence beyond the scope of the present disclosure. However, some desirable properties of the phasor iteration have been observed and can be briefly described. Consider the simple case of setting the initial state P₀. as the mean value of Pᵤ and Pᵥ This automatically applies a high weighting to areas where this initial value happens to be the true phasor P. This takes place near water-fat interfaces, i.e., transition areas between water dominating and fat dominating regions. In these areas, water and fat may have equal intensity, i.e. B=S, and then P₀=Pᵤ=Pᵥ with a large weight since otherwise there will be a reduced magnitude for P₀ due to “dephasing” between Pᵤ and Pᵥ. Therefore, the areas with correct initial state P₀ are favored and would “grow” in subsequent steps of the phasor iteration. The more sophisticated way of initialization enhances this property. It should be pointed out that these are actually troublesome areas for previous methods in which symmetric sampling of (0°, 180°) is used, since the magnitude of the opposed-phase image is zero resulting in undefined phase [11]. With POP acquisition, there is no chance to have zero magnitude unless both water and fat are zero, i.e. W=F=0, and the troublesome areas have been turned into favorable ones.

Another desirable feature of the phasor iteration is that it is able to self-correct for minor local errors that may occur in the phasor evolution. The final result is usually achieved with global phasor continuity, as a result of an evolutional balance from all pixels in the initial weighted phasor P₀. This property is very desirable as compared with those observed in typical conventional region-growing algorithms where an accidental error can often trigger a large catastrophic regional mistake. The phasor iteration process can also be potentially useful to enhance phase correction in other simple spectroscopic imaging methods [20, 28]. Owing to its simplicity, it is straightforward to apply the phasor iteration algorithm to data in 3D or higher dimensions.

Although a technique similar to that of the present embodiment has been successfully used in Canada for water-fat imaging on a large number of subjects, like any other techniques, it is not without limitations. For example, it may fail to provide the correct answer if it is tested with a phantom with only a single chemical component, such as an isolated bottle of water or oil. This single peak difficulty is a common problem for many other methods although it is mostly not clearly stated. As briefly discussed in the DPE paper [20], it is a theoretical difficulty even for localized spectroscopy since the chemical shift information can hardly be useful without a reference signal. Fortunately, such a reference is typically available in vivo where an isolated piece of tissue usually contains both water and fat, which can be references for each other. The present embodiment tends to benefit from certain regional contrast in order to set the initial phasor properly, which can be better achieved if scan time allows for three or more acquisitions using methods like DPE [20].

The present embodiment with POP acquisition offers much flexibility in pulse sequence design. Although the angle α has been most often selected as 135° in the present embodiment, it does not have to be so. It does not even have to be in the range between 0° and 180°. It can be greater than 180°, such as 225° for example, if required by sequence timing restrictions. Note that the resulting NSA* are the same for POP at 225° and 135° since NSA* is only a function of cosa as shown in Equation (33) and FIG. 3. An angle of α=135° tends to be better than 225° in terms of smaller relative phase error P in Equation (14), as well as a smaller T₂* effect. An example of using POP at α=195° is given in FIG. 8. The sampling scheme of (0, α) can be implemented with either spin-echo (as in the primary examples described herein) or gradient-echo and other sequences. The in-phase acquisition at 0° is very useful in removing large phase errors accumulated during the entire echo-time (TE) for a gradient-echo sequence. Another advantage of two-point POP acquisition is that it can be used on systems with other sources of phase errors that are not included in the traditional signal equations of Dixon acquisitions. One example is the effect of eddy currents that can introduce extra phase errors in the Dixon equations, making three or more point methods difficult.

The choice of α is quite flexible. As can be seen in FIG. 3, the NSA* remains reasonably high when α is between 120° and 240°. Of course, to be a POP acquisition, α should not be too close to 180°, otherwise desirable phase information is lost due to the perfect sampling symmetry between water and fat vectors.

In this embodiment, the final water and fat images are given by Equation (28) as a real-valued least-squares solution from the phase corrected complex images J₁ and J₂^{C} in Equations (13, 21). This solution is simpler than that described in DPE method [20] where three sets of solutions are optimally averaged, but can be proven also to offer an optimal NSA*.

Alternatively, complex-valued (W, F) solutions can also be obtained from Equations (13, 22) by inverting a 2×2complex matrix. However, the complex solutions will typically have inferior noise performance as compared to the real-valued least-squares solutions since their effective number of signal averages can be calculated as NSA*=1−cos α which is lower than that given in Equation (32).

In summary, a novel two-point method for water-fat imaging has been described in connection with an illustrative embodiment of the invention. In the illustrative embodiment, one of the two input images was acquired with magnetization vectors of protons of the first chemical component in partially-opposed phase (POP) with magnetization vectors of protons of the second chemical component. The asymmetry between water and fat magnetization vectors in the POP acquisition provides an opportunity to not only separate but also uniquely identify the two chemical species. The post processing involves a straightforward iterative phasor treatment, offering satisfactory results. The clinical utility of the method has been demonstrated with in vivo data from a large number of subjects.

Appendix I

Redundancy in (0°, 180°, 360°) and (−α, 0, α) Sampling

Assume that the phase error due to main field inhomogeneity is θ=γΔB₀t, where t is the time increment between samples, and the temporally invariant phase offset due to other factors is φ.

Case A: For (0°, 180°, 360°) sampling, the three complex images are,
I₁=(W+F)e^{iφ}
I₂=(W−F)e^{iφ}e^{iθ}
I₃=(W+F)e^{iφ}e^{i2θ}

Case B: For (−α, 0, α) sampling, we have,
I₁=(W+Fe^{-iα})e^{iφ}e^{i-θ}
I₂=(W+F)e^{iφ}
I₃=(W+Fe^{iα})e^{iφ}e^{iθ}

In both cases A and B, the third equation is not independent since its magnitude M₃ and phase P₃ are simply derivable from I₁ and I₂ as,
M₃=|I₁|
P₃=Arg(I₂²I₁*)

The only exception is in background noise or at a tissue interface where W=F, resulting in undetermined phase for some pixels. Therefore, the sampling schemes of (0°, 180°, 360°), as well as (−α, 0, α) including (−180°, 0°,180°), are essentially redundant and should be avoided.

Appendix II A Fast Smoothing Algorithm

General smoothing involves convolution of a kernel with an image, which can be slow particularly when the kernel size is large, as the processing time is usually proportional to the product of number of pixels in the kernel and the number of pixels in the image. Smoothing can often be made faster if the image is fast Fourier transformed, filtered, and transformed back to image domain. In this paper, a simple image domain fast smoothing algorithm is used for the purpose of phasor iteration with the following strategies.

First, the 2-dimensional convolution kernel is chosen to be a “square box-car”, or a sliding window of M×M pixels. This allows the 2D convolution to be performed as two sequential 1D convolutions of size M along X and Y directions, resulting in a significant reduction of processing time from M×M to 2M.

Secondly, for each 1D convolution, since the convolution kernel is a “box-car” with values of either 1 or 0, when the summation is performed within the sliding window of M pixels wide, one does not have to repeat the summation at each pixel location. The summation for one pixel differs from that of the previous pixel only by two pixel values, i.e. a new corner just included and an old pixel just left the window. Therefore, only one addition and one subtraction are needed to shift the convolution kernel by one pixel, instead of redundantly adding all pixels together within the entire sliding window after each shift of pixel location. Using the above strategy, the processing time becomes essentially independent of the kernel size, and is only proportional to the image size.

Another issue to be mentioned is that in the primary examples described herein, the fast smoothing algorithm was implemented “non-cyclically”, namely, the sliding window terminates at the end of the field of view (FOV) rather than wrapping around, to consider possible phase error discontinuity beyond FOV.

### REFERENCES

1. Dixon W T. Simple proton spectroscopic imaging. Radiology. 1984; 153:189-194.
2. Paltiel Z. Separate water and lipids images obtained by a single scan. In: Proceedings of the 4th annual scientific meeting of the Society of Magnetic Resonance in Medicine. New York: Society of Magnetic Resonance in Medicine, 1985,172-173.
3. Patrick J L, Haacke E M, Hahn J E. Water/fat separation and chemical shift artifact correction using a single scan. In: Proceedings of the 4th annual scientific meeting of the Society of Magnetic Resonance in Medicine. New York: Society of Magnetic Resonance in Medicine, 1985, 174-175.
4. Ahn C B, Lee S Y, Nalcioglu O, Cho Z H. Spectroscopic imaging by quadrature modulated echo time shifting. Magn Reson Imaging. 1986; 4: 110-111.
5. Rosen B R, Fleming D M, Kushner D C, Zaner K S, Buxton R B, Bennet W P, Wismer G L, Brady T J. Hemotologic bone marrow disorders: quantitative chemical shift MR imaging. Radiology, 1988; 169:799-804.
6. Wang Y, Li D, Haacke EM, Brown J J. A three-point Dixon method for water and fat separation using 2D and 3D gradient-echo techniques. J. Magn. Reson. Imag. 1998; 8: 703-710.
7. Yeung H N, Kormos D W. Separation of true fat and water images by correcting magnetic field inhomogeneity in situ. Radiology. 1986; 159:783-786.
8. Lodes C C, Felmlee J P, Ehman R L, Sehgal C M, Greenleaf J F, Glover G H, Gray J E. Proton MR chemical shift imaging using double and triple phase contrast acquisition methods. J. Comp. Ass. Tomography, 1989; 13:855-861.
9. Chen Q S, Schneider E, Aghazadeh B, Weinhous M S, Humm J, Ballon D. An automated iterative algorithm for water and fat decomposition in three-point Dixon magnetic resonance imaging. Med. Phys. 1999; 26: 2341-2347.
10. Glover G H, Schneider E. Three-point Dixon technique for true water/fat decomposition with B₀ inhomogeneity correction. Magn Reson Med. 1991; 18:371-383
11. Glover G H. Multipoint Dixon technique for water and fat proton and susceptibility imaging. J Magn Reson Imaging. 1991; 1 :521-530.
12. Hardy P A, Hinks R S, Tkach J A. Separation fat and water in fast-spin-echo MR imaging with the three-point Dixon technique. J Magn Reson Imaging. 1995; 5:181-185.
13. Zhang W, Goldhaber D M, Kramer D M. Separation of water and fat MR images in a single scan at .35T using “sandwich” echoes. J Magn Reson Imaging. 1996; 6:909-917.
14. Bernstein M A, King K F, Zhou X J. Handbook of MRI pulse sequences. Elsevier Academic Press. 2004.
15. Xiang Q S, An L, Aikins D, MacKay A. Phase correction in two-point Dixon chemical shift imaging. In: Proceedings of the 3rd annual scientific meeting of the Society of Magnetic Resonance. Nice: Society of Magnetic Resonance, 1995; 1904.
16. Coombs B D, Szumowski J, Coshow W, Li F. Two-point Dixon technique for water-fat signal decomposition with Bo inhomogeneity correction. In: Proceedings of the 3rd annual scientific meeting of the Society of Magnetic Resonance. Nice: Society of Magnetic Resonance, 1995; 647.
17. Akkerman E M, Maas M. A region-growing algorithm to simultaneously remove dephasing influences and separate fat and water in two-point Dixon imaging. In: Proceedings of the 3rd annual scientific meeting of the Society of Magnetic Resonance. Nice: Society of Magnetic Resonance, 1995; 649.
18. Zhu G, Huang J, Hariharan H, Freeland S. A robust water and fat separation method. In: Proceedings of the 4th annual meeting of the International Society for Magnetic Resonance in Medicine. New York: International Society for Magnetic Resonance in Medicine, 1996; 1542.
19. Skinner T E, Glover G H. An extended two-point Dixon algorithm for calculating separate water, fat, and Bo images. Magn Reson Med. 1997; 37:628-630.
20. Xiang Q S, An L. Water-fat imaging with direct phase encoding. J Magn Reson Imaging. 1997; 7:1002-1015.
21. Judge T R, Bryanston-Cross P J. A review of phase unwrapping techniques in fringe analysis. Optics and Lasers in Engineering. 1994; 21:199-239.
22. Ghiglia D C, Pritt M D, Two-dimensional phase unwrapping: theory, algorithms, and software, 1^{st} ed. New York: Wiley. 1998.
23. Chavez S, Xiang Q S, An L, Understanding phase in MRI: a new cutline phase unwrapping method”, IEEE Transactions in Medical Imaging. 2002, 21(8): 966-977.
24. Inoue Y. Imaging method of water/fat separation in MRI, U.S. Pat. No. 5,134,372, 1992.
25. Sargent M, Poskitt K J, Xiang Q S. An L. Application of a three-point method for water-fat MR imaging in children”, Pediatr. Radiol. 1999, 29: 444-448.
26. Carson B, Xiang Q S. Fat suppression using direct phase encoding: musculoskeletal Applications Using MR Imaging, AJR. 1999, 173: 230-233.
27. An L, Xiang Q S. Water-fat imaging with three orthogonal-phase acquisitions. In: Proceedings, of the 6th annual meeting of the International Society for Magnetic Resonance in Medicine. Sydney: International Society for Magnetic Resonance in Medicine, 1998; 1,866.
28. An L, Xiang Q S. Chemical shift imaging with spectrum modeling. Magn Reson Med. 2001 ; 46:126-130.
29. Ma J, Singh S K, Kumar A J, Leeds N E, Broemeling L D. Phased array coil compatible T2-weighted fast spin echo Dixon imaging. In: Proceedings of the 10th annual meeting of the International Society for Magnetic Resonance in Medicine. Honolulu: International Society for Magnetic Resonance in Medicine, 2002, 735.
30. Ma J, Bankson J A, Stafford R J. Multipoint Dixon imaging using sensitivity encoding. In: Proceedings of the 11th annual meeting of the International Society for Magnetic Resonance in Medicine. Toronto: International Society for Magnetic Resonance in Medicine, 2003,1069.
31. Reeder S B, Wen Z, Yu H, Pineda A R, Gold G E, Markl M, Pelc N J. Multicoil Dixon chemical species separation with an interactive least-squares estimation method. Magn. Reson. Med. 2004, 51: 35-45.
32. Yu H, Reeder S B, Shimakawa A, Brittain J H, Pelc N J, Robust field map estimation in a Dixon water-fat separation algorithm with short echo time increments. In: Proceedings of the 12th annual meeting of the International Society for Magnetic Resonance in Medicine. Kyoto: International Society for Magnetic Resonance in Medicine, 2004, 11.
33. An L, Xiang Q S. Quadrature 2-point water-fat imaging. In: Proceedings of the 4th annual meeting of the International Society for Magnetic Resonance in Medicine. New York: International Society for Magnetic Resonance in Medicine, 1996; 1541.
34. An L, PhD Thesis. University of British Columbia. 1998.
35. Wolfram S. A new kind of science. Wolfram Media. 2002.
36. Cipra B A, An introduction to the Ising model, Amer. Math. Monthly. 1987; 94: 937-959.
37. Ghiglia D C, Mastin G A, Romero L A. Cellular-automata method for phase unwrapping. J. Opt. Soc. Am. 1987; 4A: 267-280.
38. Xiang Q S. IR image reconstruction with multi-seed region growing spin reversal (RGSR). J. Magn. Reson. Imag. 1996; 6: 775-782.
39. Mazumdar A, Hargreaves B, Han E, Brau A, Yu H, Brittain J. Automated Fat-Water Identification in Phase Sensitive SSFP. In: Proceedings of the 13th annual meeting of the International Society for Magnetic Resonance in Medicine. Miami Beach: International Society for Magnetic Resonance in Medicine, 2005; 2307
40. Ma J. Breath-hold water and fat imaging using a dual-echo two-point technique with an efficient and robust phase-correction algorithm. Magn. Reson. Med. 2004, 52: 415-419.
   Other Alternatives

Although the main illustrative embodiment described above involves a two-point imaging method (i.e., two images of the object are input), alternatively, embodiments of the present invention may also be employed to improve imaging techniques involving three or more input images. For example, alternative embodiments of the invention may be applied as improvements to existing three-point water-fat imaging techniques, as well as other chemical shift imaging methods such as chemical shift imaging by spectrum modeling (CSISM), for example.

Although the main illustrative embodiment described above involves the application of a phasor iteration technique to achieve improved phase correction in chemical shift imaging analysis of magnetic resonance (MR) images, alternatively, such a phasor iteration technique may be applied to other phase-sensitive imaging techniques. For example, within MRI but beyond chemical shift imaging, such a phasor iteration method can also be applied to Inversion Recovery image reconstruction, where phase error correction is a key issue. Similarly, such a phasor iteration technique may be applied to achieve improved phase correction in imaging techniques other than MRI, such as optical interferometry techniques and radar imaging techniques, for example.

The main illustrative embodiment described above involves a situation in which the first image is acquired in phase (i.e., the first input image data set represents an image of the object when magnetization vectors of protons of the first chemical component are in phase with magnetization vectors of protons of the second chemical component, such that the phase shift of the first image is θ₁=0° in equation (1)). Advantageously, the method is optimized and simplified in such a situation. Alternatively, however, it is not necessary for either of the images to have been acquired “in phase” in this manner. For example, in an illustrative alternative embodiment, the first and second images may have arbitrary phase shifts θ₁, θ₂ constrained by cos(θ₁)≠cos(θ₂) and further constrained by requiring neither of the two images to have been acquired with the magnetization vectors of the first and second components in exactly opposed phase, i.e., θ₁≠(2N+1)180° and θ₂≠(2N+1)180° where N is an integer. In such an embodiment, the B and S solutions can be obtained and the phasor iteration process for phase error correction can be performed twice, on both P₁ and P₂ in equations (1) and (2). This and other similar embodiments or variations may be apparent to one of ordinary skill in the art upon review of the present disclosure.

More generally, while specific embodiments of the invention have been described and illustrated, such embodiments should be considered illustrative of the invention only and not as limiting the invention as construed in accordance with the accompanying claims.

What is claimed is:

1. An imaging method comprising:
a) performing a phasor iteration process to identify a phase error phasor associated with: a first input image data set representing a first image of an object having at least a first component and a second component, and a second input image data set representing a second image of the object; and
b) generating a first output image data set representing an image of the first component of the object, in response to the first and second input image data sets and the phase error phasor.

2. The method of claim 1 wherein the first and second components of the object comprise first and second chemical components, and wherein generating comprises generating a first output image data set representing an image of the first chemical component of the object.

3. The method of claim 2 wherein the object comprises organic tissue and wherein the first and second chemical components of the object comprise water and fat, respectively.

4. The method of claim 2 wherein the second input image data set represents an image of the object when magnetization vectors of protons of the first chemical component are in partially-opposed phase (POP) with magnetization vectors of protons of the second chemical component.

5. The method of claim 2 wherein performing a phasor iteration process comprises performing a regional iterative phasor extraction process to identify the phase error phasor.

6. The method of claim 2 wherein performing comprises identifying possible candidates for the phase error phasor to be identified.

7. The method of claim 2 wherein performing the phasor iteration process comprises setting a present iteration of the phase error phasor to be identified equal to an initial value.

8. The method of claim 6 wherein performing the phasor iteration process comprises setting a present iteration of the phase error phasor to be identified equal to an initial value, in response to the possible candidates.

9. The method of claim 7 wherein performing the phasor iteration process further comprises smoothing the present iteration of the phase error phasor.

10. The method of claim 9 wherein performing the phasor iteration process further comprises updating the smoothed present iteration of the phase error phasor for each pixel included in the first and second input image data sets.

11. The method of claim 10 further comprising repeating the smoothing and the updating to generate a plurality of successive iterations of the phase error phasor.

12. The method of claim 11 wherein repeating comprises repeating the smoothing and the updating until a number of pixels for which a most recent iteration of the phase error phasor differs from an immediately preceding iteration of the phase error phasor has stabilized, to produce a stabilized phase error phasor for each pixel.

13. The method of claim 12 wherein performing the phasor iteration process comprises identifying the phase error phasor associated with the first and second input image data sets, in response to the stabilized phase error phasor.

14. The method of claim 13 further comprising smoothing and re-normalizing the stabilized phase error phasor, and wherein identifying comprises identifying the smoothed and re-normalized stabilized phase error phasor as the phase error phasor associated with the first and second input image data sets.

15. The method of claim 13 wherein generating comprises generating a least-squares solution for the first output image data set, in response to the phase error phasor associated with the first and second input image data sets.

16. The method of claim 13 wherein generating comprises generating a complex-valued solution for the first output image data set, in response to the phase error phasor associated with the first and second input image data sets.

17. The method of claim 2 further comprising generating an output image of the first chemical component in response to the first output image data set.

18. An apparatus for imaging, the apparatus comprising a processor circuit configured to:
a) perform a phasor iteration process to identify a phase error phasor associated with: a first input image data set representing a first image of an object having at least a first component and a second component, and a second input image data set representing a second image of the object; and
b) generate a first output image data set representing an image of the first component of the object, in response to the first and second input image data sets and the phase error phasor.

19. A computer-readable medium storing instruction codes for directing a processor circuit to:
a) perform a phasor iteration process to identify a phase error phasor associated with: a first input image data set representing a first image of an object having at least a first component and a second component, and a second input image data set representing a second image of the object; and
b) generate a first output image data set representing an image of the first component of the object, in response to the first and second input image data sets and the phase error phasor.

20. An imaging apparatus comprising:
a) means for performing a phasor iteration process to identify a phase error phasor associated with: a first input image data set representing a first image of an object having at least a first component and a second component, and a second input image data set representing a second image of the object; and
b) means for generating a first output image data set representing an image of the first component of the object, in response to the first and second input image data sets and the phase error phasor.
